(19) United States
(12) Patent Application Publication
(10) Pub. No.: US 2026/0012938 A1
(43) Pub. Date: Jan. 8, 2026

(54) Semi-Persistent Scheduling Enhancements for 5G XR Services

(71) Applicant: Apple Inc., Cupertino, CA (US)

(72) Inventors: Ping-Heng KUO, London (GB); Alexander SIROTKIN, Hod Hasharon (IL); Fangli XU, Beijing (CN); Naveen Kumar R PALLE VENKATA, San Diego, CA (US); Pavan NUGGEHALLI, San Carlos, CA (US); Peng CHENG, Beijing (CN); Ralf ROSSBACH, Munich (DE); Sethuraman GURUMOORTHY, San Ramon, CA (US); Yuqin CHEN, Beijing (CN)

(21) Appl. No.: 18/881,967

(22) PCT Filed: Jul. 11, 2022
(86) PCT No.: PCT/CN2022/104970

§ 371 Date: Jan. 7, 2025

(51) Int. Cl. H04W 72/11; H04W 72/23

(52) U.S. Cl. CPC H04W 72/11; H04W 72/23

(57) ABSTRACT

A user equipment (UE) is configured to receive configuration information for a semi-persistent scheduling (SPS) configuration comprising one or more primary SPS occasions and one or more secondary SPS occasions, determine whether a next SPS occasion is a primary SPS occasion or a secondary SPS occasion, when the next SPS occasion is the secondary SPS occasion, determining whether a predetermined condition is satisfied, when the predetermined condition is satisfied, processing physical downlink shared channel (PDSCH) of the secondary SPS occasion and when the predetermined condition is not satisfied, omit processing (PDSCH) of the secondary SPS occasion.

### TECHNICAL FIELD

This application relates generally to wireless communication, and in particular relates to semi-persistent scheduling enhancements for 5G XR services.

### BACKGROUND

A fifth generation (5G) new radio (NR) network may support extended reality (XR) services. For XR traffic, the network may over-provision downlink semi-persistent scheduling (SPS) resources by using a shorter SPS periodicity compared to the anticipated packet arrival periodicity. However, for any of a variety of different reasons, over-provisioning SPS resources may result in higher power consumption and processing complexity at the user equipment (UE). Accordingly, there exists a need for techniques configured to reduce the impact on UE processing that may be caused by over-provisioning SPS resources.

### SUMMARY

Some exemplary embodiments are related to a processor of a user equipment (UE) configured to perform operations. The operations include receiving configuration information for a semi-persistent scheduling (SPS) configuration comprising one or more primary SPS occasions and one or more secondary SPS occasions, determining whether a next SPS occasion is a primary SPS occasion or a secondary SPS occasion, when the next SPS occasion is the secondary SPS occasion, determining whether a predetermined condition is satisfied, when the predetermined condition is satisfied, processing physical downlink shared channel (PDSCH) of the secondary SPS occasion and when the predetermined condition is not satisfied, omit processing (PDSCH) of the secondary SPS occasion.

Other exemplary embodiments are related to a user equipment (UE) having a transceiver configured to communicate with a base station and a processor communicatively coupled to the transceiver and configured to perform operations. The operations include receiving configuration information for a semi-persistent scheduling (SPS) configuration comprising one or more primary SPS occasions and one or more secondary SPS occasions, determining whether a next SPS occasion is a primary SPS occasion or a secondary SPS occasion, when the next SPS occasion is the secondary SPS occasion, determining whether a predetermined condition is satisfied, when the predetermined condition is satisfied, processing physical downlink shared channel (PDSCH) of the secondary SPS occasion and when the predetermined condition is not satisfied, omit processing (PDSCH) of the secondary SPS occasion.

Still further exemplary embodiments are related to a processor of a base station configured to perform operations. The operations include generating configuration information for a semi-persistent scheduling (SPS) configuration comprising one or more primary SPS occasions and one or more secondary SPS occasions and sending the configuration information to a user equipment (UE).

Additional exemplary embodiments are related to a base station having a transceiver configured to communicate with a user equipment (UE) and a processor communicatively coupled to the transceiver and configured to perform operations. The operations include generating configuration information for a semi-persistent scheduling (SPS) configuration comprising one or more primary SPS occasions and one or more secondary SPS occasions and sending the configuration information to the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for processing a semi-persistent scheduling (SPS) occasion according to various exemplary embodiments.

FIG. 5 shows an example of SPS occasions that occur at a preconfigured periodicity.

FIG. 6 shows a first example scenario comprising multiple SPS occasions.

FIG. 7 shows a second example scenario comprising multiple SPS occasions.

FIG. 8 shows a third example scenario comprising multiple SPS occasions.

FIG. 9 shows exemplary medium access control (MAC) control element (CE) that may be used for a continuation-marker and end-marker according to various exemplary embodiments.

FIG. 10 shows an exemplary abstract syntax notation one (ASN.1) for an information element (IE) indicating an SPS configuration comprising primary and secondary SPS occasions according to various exemplary embodiments.

FIG. 11 shows an exemplary ASN.1 for an IE indicating an SPS configuration comprising primary and secondary SPS occasions according to various exemplary embodiments.

### DETAILED DESCRIPTION

The exemplary embodiments may be further understood with reference to the following description and the related appended drawings, wherein like elements are provided with the same reference numerals. The exemplary embodiments relate to semi-persistent scheduling (SPS). As will be described in more detail below, a fifth generation (5G) new radio (NR) network may over-provision downlink SPS occasions by using a shorter SPS occasion periodicity compared to the anticipated packet arrival periodicity. However, denser SPS occasions may result in higher power consumption and processing complexity at the user equipment (UE). The exemplary embodiments introduce techniques to minimize the impact on UE processing that may be caused by over-provisioning SPS resources.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to 5G NR network that supports extended Reality (XR). Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). While the exemplary embodiments are described with reference to XR, it should be understood that the exemplary embodiments may be applied to any SPS resource allocation mechanism. That is, the exemplary embodiments are not limited to scenarios where the UE is engaged in XR operations.

During operation, XR services may utilize multiple data flows in the uplink and/or downlink. For example, in the downlink, there may be a video stream, an audio stream and/or a data stream. In the uplink, there may be a control stream and/or a pose stream. From a physical channel perspective, there may be different control channels and shared channels for each stream or multiple streams may share a control channel and/or shared channel. In some configurations, each stream may have different quality of service (QOS) requirements (e.g., block error rate (BLER), latency requirements, etc.).

For XR services, data payload is typically periodical. For example, a video frame rate may be 60, 90 or 120 frames per second. The network may obtain assistance information related to the characteristics of the XR traffic and utilize the assistance information to perform resource allocation for the XR services. Due to the periodical nature of XR traffic, a SPS approach may be used by the network for resource allocation.

XR traffic may have characteristics such as a quasi-periodic packet arrival rate due to random jitter and time-varying packet size. To account for these types of characteristics the network may over-provision SPS resources by utilizing a shorter SPS periodicity and thus, providing more SPS occasions compared to the expected 5G NR traffic. On the other hand, the gNB may also over-provision SPS resources when the traffic patterns cannot be efficiently or appropriately accommodated using the SPS periodicities supported by 5G NR specifications (the so called “non-integer periodicity” problems). In these cases, some of those SPS occasions may not actually contain any data. For example, downlink XR traffic may experience late packet arrival due to random jitter. The jitter is characterized by a random variable following a probability distribution and thus, the expected periodic traffic may be considered “quasi-periodic.” Late packet arrival at the base station may cause the base station to miss a physical downlink shared channel (PDSCH) opportunity (e.g., SPS occasion). In addition, due to time-varying packet size, the number of SPS occasions to be used by the network to deliver the packet to the UE may also change over time. Under conventional circumstances, the UE does not have a priori knowledge on whether an SPS occasion will actually contain data for the UE. As a result, the UE may expend power and processing resources for non-existent data transmissions, e.g., an SPS occasion that is not actually used by the base station. In addition, the UE may utilize additional power, processing and network resources sending hybrid automatic repeat request (HARQ) feedback over physical uplink control channel (PUCCH) in response to a non-existent data transmission.

The exemplary embodiments introduce techniques to minimize the impact on UE processing that may be caused by over-provisioning SPS resources. According to some aspects, the exemplary embodiments introduce a SPS configuration comprising a primary SPS occasion and a secondary SPS occasion. As will be described in more detail below, for primary SPS occasions, the UE may process the corresponding PDSCH. For secondary SPS occasions, the UE may process the corresponding PDSCH when certain conditions are met. To provide some example conditions, the UE may process a secondary SPS occasion if a preceding SPS occasion is empty (e.g., does not contain data) or if the network sends a signal instructing the UE to process a secondary SPS occasion. The exemplary SPS configuration and techniques described herein may be used independently from one another, in conjunction with currently implemented SPS mechanisms, in conjunction with future implementations of SPS mechanisms and independently from other SPS mechanisms.

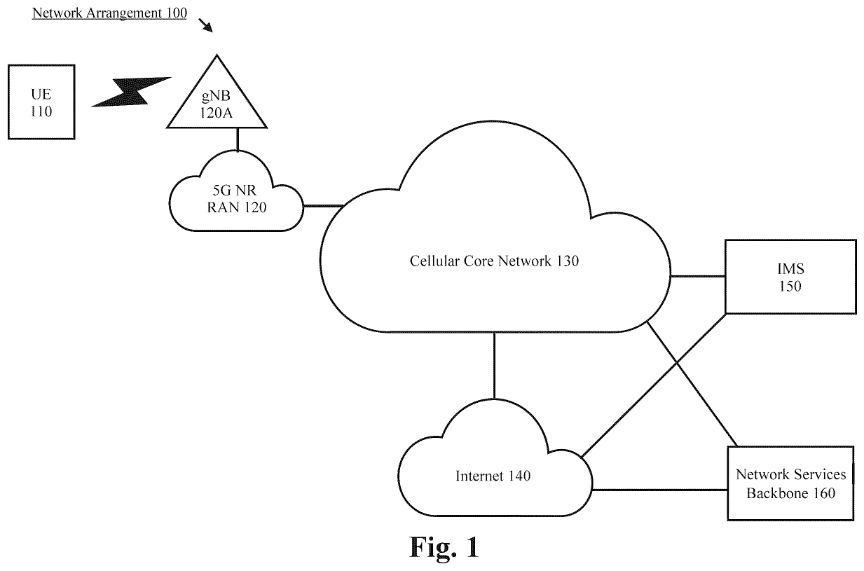

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

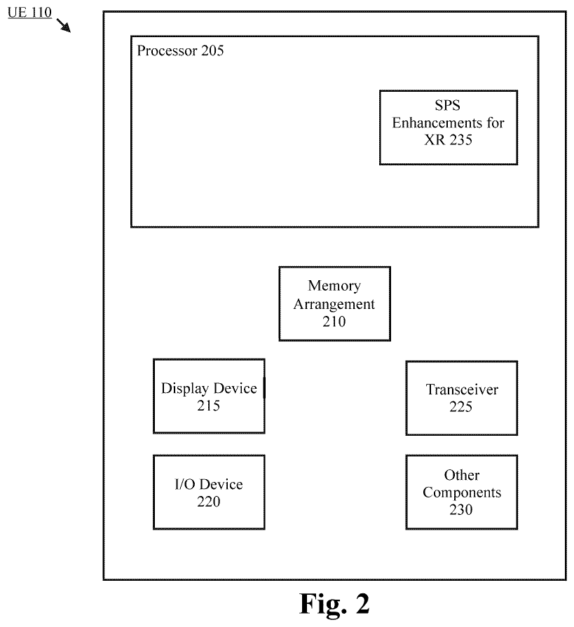

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a SPS enhancements for XR engine 235. The SPS enhancements for XR engine 235 may perform a variety of operations related to the exemplary SPS configuration and related techniques described herein. The operations may include, but are not limited to, receiving configuration information, determining whether an SPS occasion is a primary SPS occasion or a secondary SPS occasion and determining whether to process a secondary SPS occasion.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

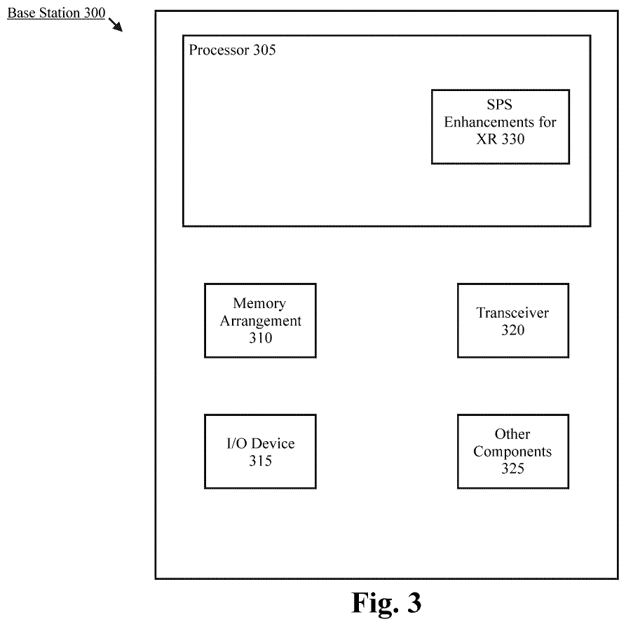

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include an SPS enhancements for XR engine 330. The SPS enhancement for XR 330 may perform a variety of operations related to the exemplary SPS configuration and related techniques described herein. The operations may include, but are not limited to, transmitting configuration information, activating/deactivating the exemplary SPS configuration and allocating radio resources to a primary SPS occasion and/or a secondary SPS occasion.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

According to some aspects, the exemplary embodiments introduce a SPS configuration comprising a primary SPS occasion and a secondary SPS occasion. For a primary SPS occasion, the UE 110 may process the corresponding PDSCH. For a secondary SPS occasion, the UE 110 may process the corresponding PDSCH when one or more predetermined conditions are met. In one example, the UE 110 may attempt to process PDSCH of a secondary SPS occasion if a preceding SPS occasion is perceived to be empty (e.g., does not contain data). In another example, the UE 110 may attempt to process PDSCH of a secondary SPS occasion if the UE 110 receives a signal from the network instructing the UE 110 to process the secondary SPS occasion. If the conditions are not met (e.g., the primary SPS occasion includes data for the UE 110, the UE 110 does not receive instructions from the network to process a secondary SPS occasion, etc.), the UE 110 may skip the secondary SPS occasion. The examples described above are provided as non-limiting examples of how the exemplary primary and secondary SPS occasions introduced herein may be utilized. Additional examples of UE and network side behavior with regard to the exemplary primary and secondary SPS occasions introduced herein are provided in more detail below. In addition, reference to the terms primary SPS occasion and secondary SPS occasion are merely provided for illustrative purposes, different entities may refer to a similar concept by a different name.

The primary SPS occasion and a corresponding secondary SPS occasion are two distinct SPS occasions that are separated in time by at least a pre-configured SPS periodicity time interval. In addition, the HARQ process ID of the primary SPS occasion and the secondary SPS occasion may be different since these SPS occasions are independent from one another. This allows the network to have adequate resources available for the UE 110 if a transmission cannot be transmitted on time due to late packet arrival caused by jitter. Further, this configuration may enable the network segment a packet into multiple transport blocks in the MAC and send the payload data to the UE 110 across both the primary SPS and secondary SPS occasions.

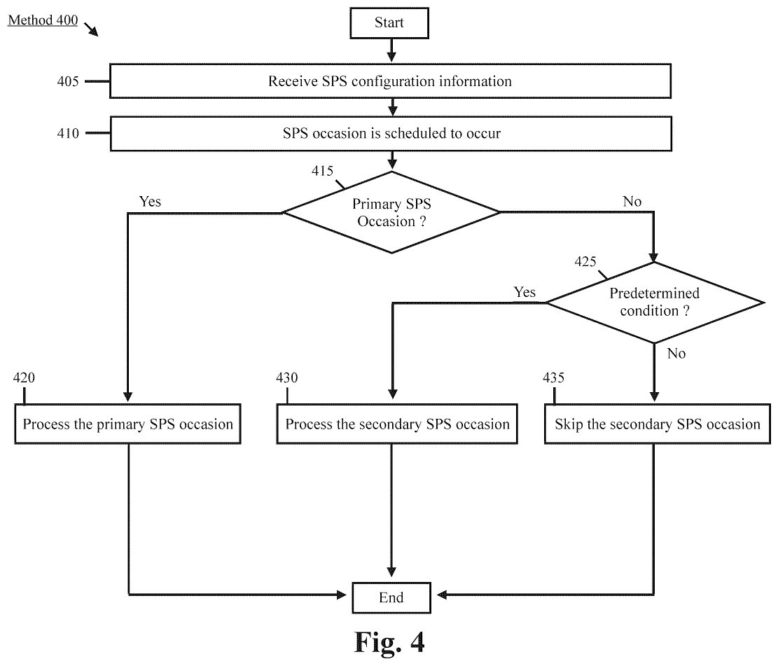

FIG. 4 shows a method 400 for processing an SPS occasion according to various exemplary embodiments. The method 400 is described with regard to the network arrangement 100 of FIG. 1 and from the perspective of the UE 110.

In 405, the UE 110 receives SPS configuration information from the gNB 120A. The SPS configuration information may include configuration information related to primary SPS occasions and secondary SPS occasions. For example, the SPS configuration information may enable the UE 110 to differentiate between primary SPS occasions and secondary SPS occasions. In some embodiments, the configuration information may indicate the parameters of a SPS occasion cycle comprising a pattern of consecutive one or more primary SPS occasions and one or more secondary SPS occasions.

The SPS configuration information may be provided to the UE 110 in one or more radio resource control (RRC) messages or any other appropriate type of signal. Examples of different exemplary RRC messages that may be utilized to provide the exemplary SPS configuration information described herein are provided in detail below after the description of the method 400.

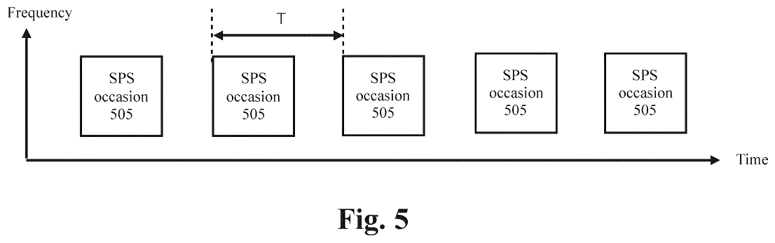

In 410, an SPS occasion is scheduled to occur. Those skilled in the art will understand that SPS occasions may be preconfigured downlink radio resources with time and frequency locations that are known to the UE 110. This enables the UE 110 to receive PDSCH without dynamic signaling from the network for downlink resource allocation. SPS occasions may be configured to occur at a preconfigured periodicity, an example of which is shown in FIG. 5. In the example 500 of FIG. 5, SPS occasions 505 include PDSCH resources and occur at a periodicity (T).

Returning to FIG. 4, in 415, the UE 110 determines whether the SPS occasion is a primary SPS occasion. The UE 110 may make this determination based on information received from the gNB 120A, information hard-encoded in 3GPP specifications, information preconfigured at the UE 110, a combination thereof or on any other appropriate basis.

If the SPS occasion is a primary SPS occasion, the method 400 continues to 420. In 420, the UE 110 processes the primary SPS occasion. For example, the UE 110 may tune its transceiver 225 to monitor the SPS occasion, receive PDSCH resources and decode the PDSCH resources. The method 400 is described from the perspective of the UE 110 processing a single SPS occasion which may be either a primary SPS occasion or a secondary SPS occasion. However, in an actual deployment scenario, after the UE 110 process the primary SPS occasion the UE 110 may return to 410 to process a next SPS occasion which may either be a primary SPS occasion or a secondary SPS occasion depending on the SPS occasion configuration being utilized.

Returning to 415, if the SPS occasion is not a primary SPS occasion, the SPS occasion is a secondary SPS occasion and the method 400 continues to 425. In 425, the UE 110 determines whether a predetermined condition has occurred. The predetermined condition may trigger the UE 110 to process the secondary SPS occasion. Otherwise, the UE 110 may skip processing the secondary SPS occasion. As will be described in the examples below, this approach may provide the network with ample SPS occasions to adequately handle issues like late packet arrival and time-varying packet size while limiting the instances in which the UE 110 processes a SPS occasion that does not actually contain any data.

In one example, the predetermined condition may relate to whether a previous primary SPS occasion was perceived to be empty by the UE 110. For instance, the gNB 120A may miss a primary SPS occasion due to late packet arrival caused by jitter. The UE 110 may be unaware that the gNB 120A missed the primary SPS occasion and attempt to decode PDSCH during the primary SPS occasion. As a result, the UE 110 may determine that the primary SPS occasion does not contain data. When the primary SPS occasion is perceived to be empty, it may be assumed that a corresponding secondary SPS occasion is likely to contain PDSCH. Accordingly, in this example, the UE 110 may process a secondary SPS occasion when a previous primary SPS occasion is perceived to be empty. However, if a primary SPS occasion contains data, the UE 110 may assume that a subsequent secondary SPS occasion will not contain data and the UE 110 may skip processing the secondary SPS occasion. This may include discontinuing at least a subset of processing functionality associated PDSCH reception during the secondary SPS occasion which may allow the UE 110 to save power and processing resources.

In another example, the predetermined condition may relate to whether the UE 110 has received a signal from the network instructing the UE 110 to processing the secondary SPS occasion. For instance, the gNB 120A may send a medium access control (MAC) control element (CE), downlink control information (DCI) or any other appropriate type of signal to the UE 110 instructing the UE 110 to process one or more upcoming secondary SPS occasions. The network may utilize this signal when the gNB 120A misses a primary SPS occasion due to late packet arrival caused by jitter. In addition, the network may also utilize this exemplary technique when the incoming packet actually requires more than one SPS occasion to fully transmit. Thus, in this example, the UE 110 may process the secondary SPS occasion even when a previous primary SPS occasion contains PDSCH.

The examples described above were provided as a general overview of the type of exemplary predetermined conditions that may be utilized to trigger the UE 110 to process a secondary SPS occasion. Additional examples of processing primary and secondary SPS occasions are provided in detail below after the description of the method 400.

Returning to 425, if the predetermined condition is satisfied, the method 400 continues to 430. In 430, the UE 110 processes the secondary SPS occasion. If the predetermined condition is not satisfied, the method 400 continues to 435. In 435, the UE 110 may skip processing the secondary SPS occasion. As mentioned above, this may include discontinuing at least a subset of processing functionality associated PDSCH reception during the secondary SPS occasion.

In some embodiments, the network may selectively activate and deactivate the exemplary SPS configuration described herein. To provide an example, at a first time, the gNB 120A may send SPS configuration information to the UE 110 comprising configuration information for primary and secondary SPS occasions that enable the UE 110 to differentiate between the different types of SPS occasions. However, until the network sends an activation signal (e.g., MAC CE or any other appropriate signal) the UE 110 handles SPS occasions in the legacy manner. Once activated by the network, the UE 110 may then proceed to determine whether an SPS occasion is a primary SPS occasion or a secondary SPS occasion prior to processing an SPS occasion. The network may subsequently deactivate the exemplary SPS configuration, and the UE 110 may return to handling SPS occasions in the legacy manner.

In some embodiments, the network may instruct the UE 110 not to process certain primary SPS occasions. For example, if the gNB 120A knows a packet expected at a certain time will not arrive in time (e.g., already lost before entering 5G system), the gNB 120A may send a signal to the UE 110 indicating to the UE 110 that one or more primary SPS occasions are not to be processed by the UE 110.

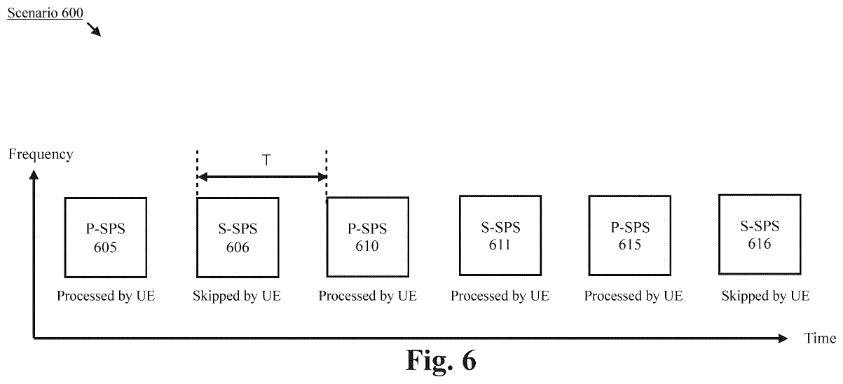

The following exemplary scenarios 600-800 are provided to illustrate some non-limiting examples of UE 110 and network behavior with regard to the exemplary SPS configuration introduced herein. FIG. 6 shows example scenario 600 comprising multiple SPS occasions. In example scenario 600, each SPS occasion is scheduled to occur at a periodicity (T) and primary SPS occasions (P-SPS) alternate in time with secondary SPS occasions (S-SPS).

Initially, assume the gNB 120A assigns SPS occasions that match the nominal timing of packet arrival as P-SPS and that the UE 110 is configured to process a S-SPS based on whether a preceding P-SPS contains data for the UE 110. If a P-SPS is perceived to be empty by the UE 110, the UE 110 may process the next S-SPS and If the P-SPS contains data, the UE 110 may skip processing the next S-SPS. In example scenario 600, P-SPS 605 contains data for the UE 110 and thus, the UE 110 does not process the subsequent S-SPS 606. At the gNB 120A, due to late packet arrival caused by jitter, the gNB 120 may miss the P-SPS 610 and thus, P-SPS 610 does not actually contain any data for the UE 110. When the UE 110 processes P-SPS 610 and determines that P-SPS 610 does not contain data, the UE 110 may be triggered to process the subsequent S-SPS 611. The next P-SPS 615 contains data for the UE 110 and thus, the UE 110 does not process the subsequent S-SPS 616.

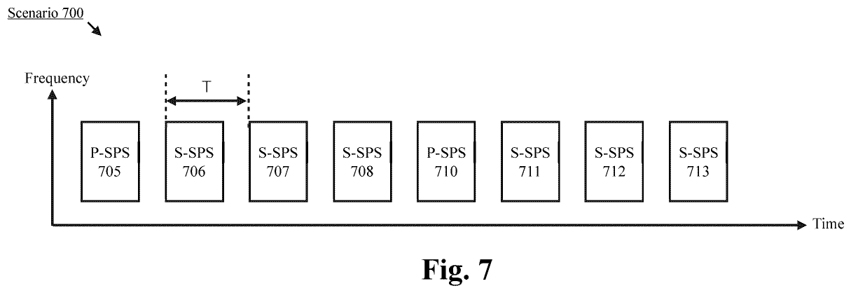

FIG. 7 shows example scenario 700 comprising multiple SPS occasions. In example scenario 700, each SPS occasion is scheduled to occur at a periodicity (T) and each P-SPS is followed by three S-SPS. However, reference to a cycle configured to include a single P-SPS followed by three S-SPS is merely provided for illustrative purposes. Each P-SPS may be configured with any appropriate number of S-SPS. Here, P-SPS 705 is followed by S-SPS 706, S-SPS 707 and S-SPS 708 and P-SPS 710 is followed by S-SPS 711, S-SPS 712 and S-SPS 713.

In example scenario 700, if a P-SPS is perceived to be empty, the UE 110 may process one or more subsequent S-SPS. For instance, if P-SPS 705 is perceived to be empty, the UE 110 may process one or more of S-SPS 706-708. However, if P-SPS 705 contains data, the UE 110 may skip processing S-SPS 706-708. Similarly, if P-SPS 710 is perceived to be empty, the UE 110 may process one or more of S-SPS 711-713. However, if P-SPS 710 contains data, the UE 110 may skip processing S-SPS 711-713.

In some embodiments, if a P-SPS is perceived to be empty, the UE 110 may process all S-SPS until the next P-SPS occurs regardless of whether any data is received in the subsequent S-SPS. For example, if P-SPS 705 is perceived to be empty by the UE 110, the UE 110 may process S-SPS 706-708 regardless of whether any or all of S-SPS 706-708 contain data for the UE 110.

In another embodiment, if a P-SPS is perceived to be empty, the UE 110 may process subsequent S-SPS until one of the S-SPS is determined to contain data for the UE 110. For example, if P-SPS 705 is perceived to be empty by the UE 110, the UE 110 may then process S-SPS 706. If S-SPS 706 contains data, the UE 110 may skip processing S-SPS 707, 708. However, if S-SPS 706 is perceived to be empty, the UE 110 may then process S-SPS 707. If S-SPS 707 contains data, the UE 110 may skip processing S-SPS 708. However, If S-SPS 707 is perceived to be empty the UE 110 may then process S-SPS 708.

In a further embodiment, if a P-SPS is perceived to be empty, the UE 110 may select one or more of the subsequent S-SPS for processing. The S-SPS selected by the UE 110 may be based on an indication received from the network, information hard-encoded in 3GPP specifications, information preconfigured at the UE 110, a combination thereof or on any other appropriate basis. For example, if the P-SPS 705 is perceived to be empty, the UE 110 may select one or more S-SPS from S-SPS 706-708 for processing.

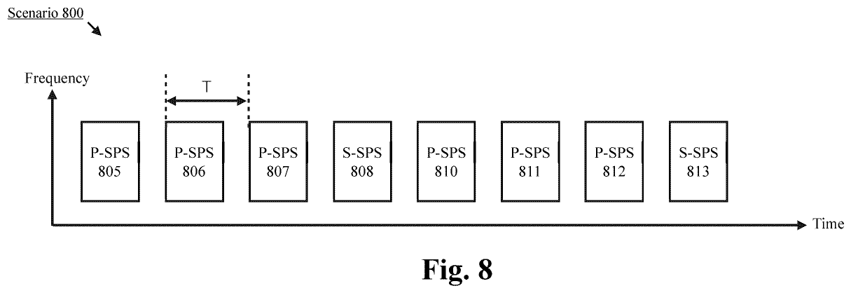

FIG. 8 shows example scenario 800 comprising multiple SPS occasion. In example scenario 800, each SPS occasion is scheduled to occur at a periodicity (T). There are three consecutive P-SPS followed by a single S-SPS. However, reference to a cycle configured to include three P-SPS followed by a single S-SPS is merely provided for illustrative purposes. Any appropriate number of consecutive P-SPS may be configured with any appropriate number of S-SPS. Here, P-SPS 805-807 are followed by S-SPS 808 and P-SPS 810-812 are followed by S-SPS 813. In example scenario 800, the UE 110 may only process a S-SPS if the UE 110 could not decode data from any one of the three consecutive P-SPS. For example, if the UE 110 perceives any one of P-SPS 805-807 to be empty the UE 110 may process S-SPS 808.

In some embodiments, a SPS occasion cycle may include (M>1) P-SPS followed by (N>1) S-SPS. In this type of scenario, a combination of the rules described above with regard to example scenarios 700 and 800 may be utilized. For instance, when one or more of the (M) P-SPS are perceived to be empty by the UE 110, the UE 110 may process all of the (N) S-SPS until data is received from (M) of (N) S-SPS (or until the network indicates that the UE 110 may skip the remaining S-SPS of the cycle). In another example, when all of (M) P-SPS are perceived to be empty, the UE 110 may select (M) out of the (N) S-SPS for processing. The S-SPS selected by the UE 110 may be based on an indication received from the network, information hard-encoded in 3GPP specifications, information preconfigured at the UE 110, a combination thereof or on any other appropriate basis.

According to some aspects, the exemplary embodiments introduce a “continuation-marker” and an “end-marker.” These markers may be included in a SPS occasion to instruct the UE 110 to process or skip a subsequent secondary SPS occasion. Throughout this description, the term “continuation-marker” may refer to an indication provided in a SPS occasion that indicates to the UE 110 that the UE 110 is to process a next secondary SPS occasion. The term “end-marker” may refer to an indication in a SPS occasion that indicates to the UE 110 that the UE 110 is to skip a next SPS occasion. However, reference to the terms “continuation-marker” and “end-marker” are merely provided for illustrative purposes, different entities may refer to similar concepts by a different name.

According to some aspects, the network may utilize a continuation-marker when a packet requires more than one SPS occasion to fully transit the content of a packet and thus, the UE 110 may need to decode a primary SPS occasion and one or more secondary SPS occasions to decode the entire packet. Further, the continuation-marker may also include additional information such as, but not limited to, a number of subsequent secondary SPS occasions the UE 110 is to process and/or a time duration during which the UE 110 is to process secondary SPS occasions. Similarly, the end-marker may also include additional information such as, but not limited to, a number of subsequent secondary SPS occasions the UE 110 is skip and/or a time duration during which the UE 110 is to skip processing secondary SPS occasions. However, the exemplary embodiments do not limit the use of the continuation-marker and end-marker to this type of scenario. The continuation-marker and end-marker described herein may be used in any appropriate type of scenario and independently from one another.

In some embodiments, the continuation-marker and end-marker may be implemented using a MAC CE or DCI. In other embodiments, the continuation-marker and end-marker may be implemented as a wake-up signal (WUS) where the UE 110 may determine whether it is to process a subsequent secondary SPS occasion based on if the UE 110 detects the WUS (e.g., sufficiently high energy during a timer interval, etc.).

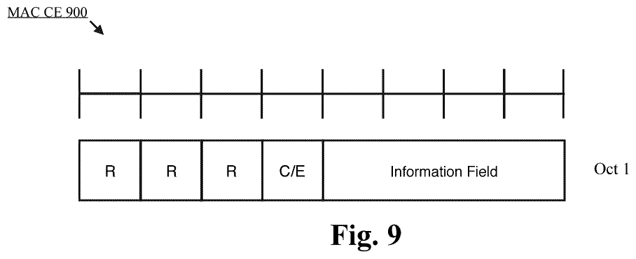

FIG. 9 shows exemplary MAC CE 900 that may be used for a continuation-marker and/or end-marker according to various exemplary embodiments. The exemplary MAC CE 900 may be included in the MAC packet data unit (PDU) for the PDSCH of a primary SPS occasion or a secondary SPS occasion, which allows the UE 110 to know whether it should process subsequent secondary SPS occasions. In this example, the C/E field may be used to indicate whether the MAC CE is a continuation-marker or an end-marker. The information field may include further information about the marker. For example, the information field may be used to indicate a validity interval indicating a time duration or a number of subsequent secondary SPS occasions the UE 110 is to process or refrain from processing. In another example, the information field may be used to indicate one or more (e.g., a subset, etc.) secondary SPS occasions the UE 110 should decode or skip until the next primary SPS occasion.

As mentioned above, in some embodiments, the UE 110 may process a SPS occasion based on a condition related to a preceding SPS occasion, e.g., whether a preceding SPS occasion is empty, whether an indication is present in the preceding SPS occasion instructing the UE 110 to process or omit a next SPS occasion, etc. This approach may also be utilized for physical downlink control channel (PDCCH)-based downlink resource allocation. Thus, the UE 110 may determine whether the UE 110 is to process a SPS occasion based on a condition related to a dynamically scheduled PDSCH.

In some embodiments, a secondary SPS occasion may be scheduled prior to its corresponding primary SPS occasion. In this type of scenario, if the packet arrives earlier than expected at the gNB 120A (e.g., earlier than the nominal timing), the gNB 120A may schedule PDSCH that overlaps with the secondary SPS occasion that is earlier than its corresponding primary SPS occasion so that the UE 110 does not miss any packets that arrive earlier than expected at the gNB 120A. Thus, the UE 110 may be configured to monitor PDCCH during a time interval before the primary SPS occasion. Alternatively, the gNB 120A may hold the packet and only transmit the packet until the scheduling timing of the primary SPS occasion.

As discussed above with regard to the method 400, the network may send the UE 110 SPS configuration information to enable the UE 110 to determine whether an SPS occasion is a primary SPS occasion or a secondary SPS occasion. In one example, the gNB 120A may provide a bitmap where a first value (e.g., 1) indicates a primary SPS occasion and a second value (e.g., 0) indicates a secondary SPS occasion (or vice versa). The bitmap may be provided in an RRC message and/or a MAC CE and may be cyclically applied by the UE 110 to determine the type of SPS occasions over a SPS configuration. For example, if a cycle of SPS occasions comprises a primary SPS occasion followed by three secondary SPS occasions like in the exemplary scenario 700, the bitmap provided to the UE 110 may be (1000).

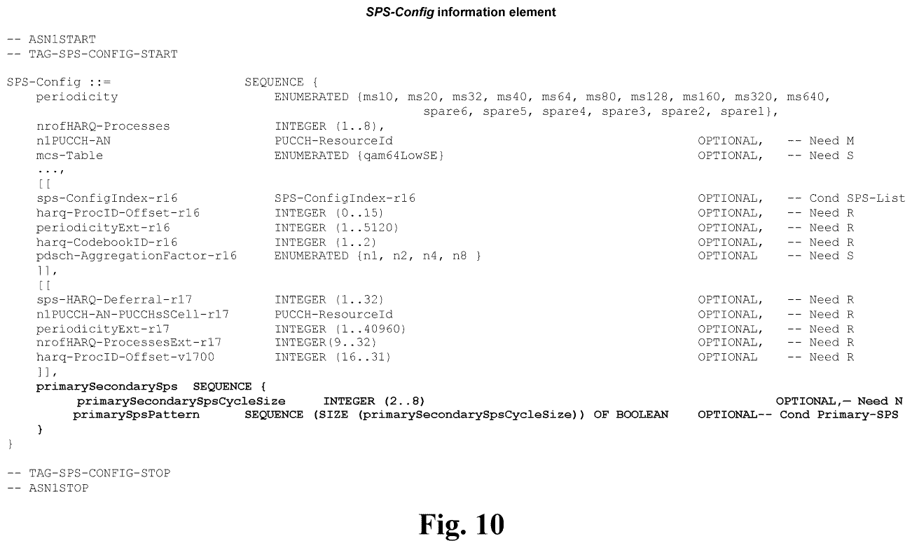

FIG. 10 shows an exemplary abstract syntax notation one (ASN.1) 1000 for an IE indicating an SPS configuration comprising primary and secondary SPS occasions. In this example, an exemplary IE entitled “primarySecondarySPS” is included in an SPS-Config IE. The exemplary primarySecondarySPS IE indicates that the exemplary SPS configuration described herein may be utilized and includes a primarySecondarySpsCycleSize parameter indicating a number of SPS occasions in an SPS occasion cycle comprising a pattern of one or more primary SPS occasions and one or more secondary SPS occasions. In addition, the exemplary primarySecondarySPS IE includes a primarySPSPattern parameter that may be used to provide the bitmap indicating the location of the primary SPS occasions and secondary SPS occasions within the cycle. This example assumes that primary SPS occasions and secondary SPS occasions may be flexibly allocated in one cycle. In this example, the conditional parameter “primary-SPS” may be present when the SPS configuration is configured to have primary and secondary SPS occasions.

In another approach, the gNB 120A may provide SPS configuration information comprising one or more parameters for the UE 110 to determine the SPS occasion type based on a formula. In another approach, the UE 110 may determine the SPS occasion type by itself based on the SPS occasion characteristics such as, but not limited to, slot index and/or orthogonal frequency division multiplexing (OFDM) symbol indices of the corresponding PDSCH.

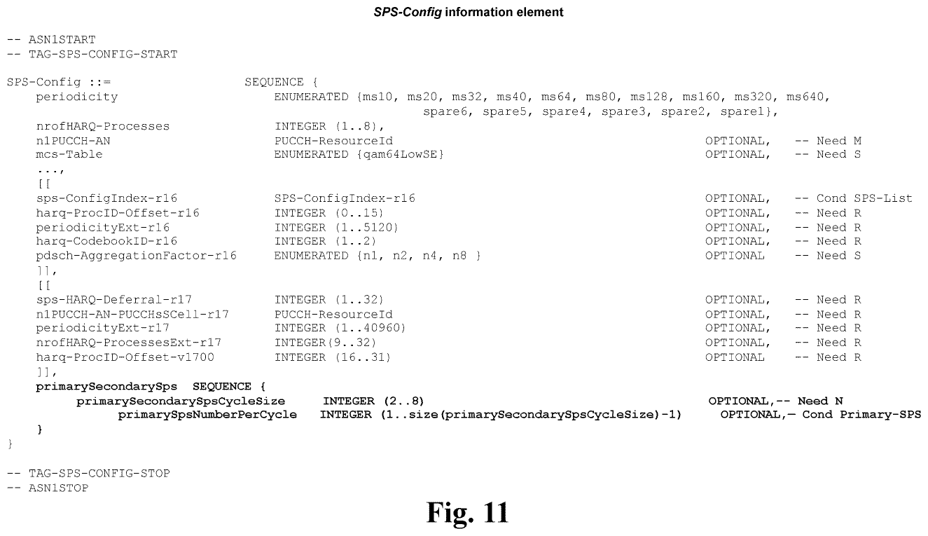

In a further approach, the gNB 120A may configure the UE 110 to treat every N-th SPS occasion as primary SPS occasion based on a counter (or any other appropriate mechanism). FIG. 11 shows an exemplary ASN.1 1100 for an IE indicating an SPS configuration comprising primary and secondary SPS occasions. In this example it is assumed that a SPS occasion cycle comprises M+N consecutive SPS occasions where M represents a number of primary SPS occasions in the cycle and N represents a number of secondary SPS occasions in the cycle. In this example, an exemplary IE entitled “primarySecondarySPS” is included in an SPS-Config IE. The exemplary primarySecondarySPS IE indicates that the exemplary SPS configuration described herein may be utilized and includes a primarySecondarySpsCycleSize parameter indicating a number of SPS occasions in an SPS occasion cycle. In addition, the exemplary primarySecondarySPS IE includes a primarySPSNumberPerCycle parameter indicating a number of primary SPS occasions in each cycle, the other SPS occasions in the cycle may be considered secondary SPS occasions. The UE 110 may utilize the counter approach with the information conveyed in this exemplary RRC message to treat every N-th SPS as a primary SPS occasion.

### EXAMPLES

In a first example, a user equipment (UE) comprises a transceiver configured to communicate with a base station and a processor communicatively coupled to the transceiver and configured to perform operations comprising receiving configuration information for a semi-persistent scheduling (SPS) configuration comprising one or more primary SPS occasions and one or more secondary SPS occasions, determining whether a next SPS occasion is a primary SPS occasion or a secondary SPS occasion, when the next SPS occasion is the secondary SPS occasion, determining whether a predetermined condition is satisfied, when the predetermined condition is satisfied, processing physical downlink shared channel (PDSCH) of the secondary SPS occasion and when the predetermined condition is not satisfied, omit processing (PDSCH) of the secondary SPS occasion.

In a second example, the UE of the first example, wherein the primary SPS occasion and the secondary SPS occasion are associated with a different hybrid automatic request (HARQ) process ID.

In a third example, the UE of the first example, wherein the primary SPS occasion and the secondary SPS occasion are separated by a preconfigured SPS periodicity time interval.

In a fourth example, the UE of the first example, wherein determining whether the next SPS occasion is the primary SPS occasion or the secondary SPS occasion is based on the SPS configuration information.

In a fifth example, the UE of the fourth example, wherein the SPS configuration information is provided in a radio resource control (RRC) message and comprises a parameter indicating a number of SPS occasions in an SPS occasion cycle.

In a sixth example, the UE of the fifth example, wherein the SPS configuration information further comprises a bitmap identifying a pattern of the one or more primary SPS occasions and the one or more secondary SPS occasions within the SPS occasion cycle.

In a seventh example, the UE of the fifth example, wherein the SPS configuration information further comprises a parameter indicating a number of primary SPS occasions within the SPS occasion cycle.

In an eighth example, the UE of the first example, wherein the predetermined condition is whether a previous primary SPS occasion was determined to be empty by the UE.

In a ninth example, the UE of the first example, wherein an SPS cycle comprises multiple consecutive SPS occasions comprising one primary SPS occasion and two or more secondary SPS occasions.

In a tenth example, the UE of the ninth example, wherein the UE is configured to process each of the two or more secondary SPS occasions when the one primary SPS occasion is determined to be empty by the UE and the UE is configured to skip the two or more secondary SPS occasions when the one primary SPS occasion is determined to contain physical downlink shared channel (PDSCH) for the UE.

In an eleventh example, the UE of the ninth example, wherein the UE is configured to process each instance of the two or more secondary SPS occasions until one instance of the two or more secondary SPS occasions is determined to contain physical downlink shared channel (PDSCH) when the one primary SPS occasion is determined to be empty by the UE and the UE is configured to skip the two or more SPS occasions when the one primary SPS occasion is determined to contain PDSCH for the UE.

In a twelfth example, the UE of the ninth example, wherein the UE is configured to select a subset of the two or more secondary SPS occasions for processing when the one primary SPS occasion is determined to be empty by the UE and the UE is configured to skip the two or more secondary SPS occasions when the one primary SPS occasion is determined to contain physical downlink shared channel (PDSCH) for the UE.

In a thirteenth example, the UE of the first example, wherein an SPS cycle comprises multiple consecutive SPS occasions comprising two or more primary SPS occasions and one secondary SPS occasion.

In a fourteenth example, the UE of the thirteenth example, wherein the UE is configured to process the one secondary SPS occasion when at least one instance of the two or more primary SPS occasions are determined to be empty by the UE and the UE is configured to skip the one secondary SPS occasion when each of the two or more primary SPS occasions are determined to contain physical downlink shared channel (PDSCH) for the UE.

In a fifteenth example, the UE of the first example, wherein the predetermined condition is whether the UE receives an indication from the network instructing the UE to process the secondary SPS occasion or refrain from processing the secondary SPS occasion.

In a sixteenth example, the UE of the fifteenth example, wherein the indication is provided in a medium access control (MAC) control element (CE) that is received by the UE during a previous SPS occasion.

In a seventeenth example, the UE of the sixteenth example, wherein the MAC CE further comprises a parameter indicating a time duration during which the UE is to process or refrain from processing subsequent SPS occasions.

In an eighteenth example, the UE of the sixteenth example, wherein the MAC CE further comprises a parameter indicating a number of subsequent SPS occasions the UE is to process or refrain from processing.

In a nineteenth example, the UE of the fifteenth example, wherein the indication is provided in downlink control information (DCI) that is received by the UE during a previous SPS occasion.

In a twentieth example, the UE of the fifteenth example, wherein the indication is provided in a wake-up signal.

In a twenty first example, a base station comprises a transceiver configured to communicate with a user equipment (UE) and a processor communicatively coupled to the transceiver and configured to perform operations comprising generating configuration information for a semi-persistent scheduling (SPS) configuration comprising one or more primary SPS occasions and one or more secondary SPS occasions and sending the configuration information to the UE.

In a twenty second example, the base station of the twenty first example, wherein the configuration information is sent in a radio resource control (RRC) message and comprises a parameter indicating a number of SPS occasions in an SPS occasion cycle.

In a twenty third example, the base station of the twenty second example, wherein the SPS configuration information further comprises a bitmap identifying a pattern of the one or more primary SPS occasions and the one or more secondary SPS occasions within the SPS occasion cycle.

In a twenty fourth example, the base station of the twenty third example, wherein the SPS configuration information further comprises a parameter indicating a number of primary SPS occasions within the SPS occasion cycle.

In a twenty fifth example, the base station of the twenty first example, wherein the operations further comprise sending an indication instructing the UE to process the one or more secondary SPS occasions or refrain from processing the one or more secondary SPS occasions.

In a twenty sixth example, the base station of the twenty fifth example, wherein the indication is sent in a medium access control (MAC) control element (CE) that is sent during a previous SPS occasion.

In a twenty seventh example, the base station of the twenty sixth example, wherein the MAC CE further comprises a parameter indicating a time duration during which the UE is to process or refrain from processing subsequent SPS occasions.

In a twenty eighth example, the base station of the twenty sixth example, wherein the MAC CE further comprises a parameter indicating a number of subsequent SPS occasions the UE is to process or refrain from processing.

In a twenty ninth example, the base station of the twenty fifth example, wherein the indication is sent in downlink control information (DCI) that is received by the UE during a previous SPS occasion.

In a thirtieth example, the base station of the twenty fifth example, wherein the indication is provided in a wake-up signal.

In a thirty first example, the base station of the twenty first example, wherein at least one secondary SPS occasion is scheduled prior to a corresponding primary SPS occasion.

In a thirty second example, the base station of the thirty first example, wherein the operations further comprise scheduling a Physical Downlink Shared Channel (PDSCH) that overlaps with the at least one secondary SPS occasion.

In a thirty third example, the base station of the thirty first example holding a packet to be transmitted on a Physical Downlink Shared Channel (PDSCH) until a scheduling timing of the corresponding primary SPS occasion.

Those skilled in the art will understand that the above-described exemplary embodiments may be implemented in any suitable software or hardware configuration or combination thereof. An exemplary hardware platform for implementing the exemplary embodiments may include, for example, an Intel ×86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations, the operations comprising:
receiving configuration information for a semi-persistent scheduling (SPS) configuration comprising one or more primary SPS occasions and one or more secondary SPS occasions;
determining whether a next SPS occasion is a primary SPS occasion or a secondary SPS occasion;
when the next SPS occasion is the secondary SPS occasion, determining whether a predetermined condition is satisfied;
when the predetermined condition is satisfied, processing physical downlink shared channel (PDSCH) of the secondary SPS occasion; and
when the predetermined condition is not satisfied, omit processing (PDSCH) of the secondary SPS occasion.

2. The processor of claim 1, wherein the primary SPS occasion and the secondary SPS occasion are associated with a different hybrid automatic request (HARQ) process ID.

3. The processor of claim 1, wherein the primary SPS occasion and the secondary SPS occasion are separated by a preconfigured SPS periodicity time interval.

4. The processor of claim 1, wherein determining whether the next SPS occasion is the primary SPS occasion or the secondary SPS occasion is based on the SPS configuration information.

5. The processor of claim 4, wherein the SPS configuration information is provided in a radio resource control (RRC) message and comprises a parameter indicating a number of SPS occasions in an SPS occasion cycle.

6. The processor of claim 1, wherein the predetermined condition is whether a previous primary SPS occasion was determined to be empty by the UE.

7. The processor of claim 1, wherein an SPS cycle comprises multiple consecutive SPS occasions comprising one primary SPS occasion and two or more secondary SPS occasions.

8. The processor of claim 7, wherein the UE is configured to process each of the two or more secondary SPS occasions when the one primary SPS occasion is determined to be empty by the UE and the UE is configured to skip the two or more secondary SPS occasions when the one primary SPS occasion is determined to contain physical downlink shared channel (PDSCH) for the UE.

9. The processor of claim 7, wherein the UE is configured to process each instance of the two or more secondary SPS occasions until one instance of the two or more secondary SPS occasions is determined to contain physical downlink shared channel (PDSCH) when the one primary SPS occasion is determined to be empty by the UE and the UE is configured to skip the two or more SPS occasions when the one primary SPS occasion is determined to contain PDSCH for the UE.

10. The processor of claim 7, wherein the UE is configured to select a subset of the two or more secondary SPS occasions for processing when the one primary SPS occasion is determined to be empty by the UE and the UE is configured to skip the two or more secondary SPS occasions when the one primary SPS occasion is determined to contain physical downlink shared channel (PDSCH) for the UE.

11. The processor of claim 1, wherein an SPS cycle comprises multiple consecutive SPS occasions comprising two or more primary SPS occasions and one secondary SPS occasion, wherein the UE is configured to process the one secondary SPS occasion when at least one instance of the two or more primary SPS occasions are determined to be empty by the UE and the UE is configured to skip the one secondary SPS occasion when each of the two or more primary SPS occasions are determined to contain physical downlink shared channel (PDSCH) for the UE.

12. The processor of claim 1, wherein the predetermined condition is whether the UE receives an indication from the network instructing the UE to process the secondary SPS occasion or refrain from processing the secondary SPS occasion.

13. The processor of claim 12, wherein the indication is provided in a medium access control (MAC) control element (CE) that is received by the UE during a previous SPS occasion, wherein the MAC CE further comprises a parameter indicating (i) a time duration during which the UE is to process or refrain from processing subsequent SPS occasions or (ii) a number of subsequent SPS occasions the UE is to process or refrain from processing.

14. The processor of claim 12, wherein the indication is provided in downlink control information (DCI) that is received by the UE during a previous SPS occasion or a wake-up signal.

15. A processor of a base station configured to perform operations comprising:
generating configuration information for a semi-persistent scheduling (SPS) configuration comprising one or more primary SPS occasions and one or more secondary SPS occasions; and
sending the configuration information to a user equipment (UE).

16. The processor of claim 15, wherein the configuration information is sent in a radio resource control (RRC) message and comprises a parameter indicating a number of SPS occasions in an SPS occasion cycle.

17. The processor of claim 16, wherein the SPS configuration information further comprises a bitmap identifying a pattern of the one or more primary SPS occasions and the one or more secondary SPS occasions within the SPS occasion cycle.

18. The processor of claim 17, wherein the SPS configuration information further comprises a parameter indicating a number of primary SPS occasions within the SPS occasion cycle.

19. The processor of claim 15, wherein the operations further comprise:
sending an indication instructing the UE to process the one or more secondary SPS occasions or refrain from processing the one or more secondary SPS occasions, wherein the indication is sent in a medium access control (MAC) control element (CE) that is sent during a previous SPS occasion.

20. The processor of claim 15, wherein at least one secondary SPS occasion is scheduled prior to a corresponding primary SPS occasion.

21-22. (canceled)
